(19) United States
(12) Patent Application Publication
(10) Pub. No.: US 2025/0104890 A1
(43) Pub. Date: Mar. 27, 2025

(54) ELECTRICAL FEEDTHROUGH AND ENERGY STORE WITH SUCH A FEEDTHROUGH

(71) Applicant: Schott AG, Mainz (DE)

(72) Inventors: Helmut Hartl, Klosterneuburg (AT); Björn Ramdohr, Landshut (DE)

(73) Assignee: Schott AG, Mainz (DE)

(21) Appl. No.: 18/730,199

(22) PCT Filed: Dec. 14, 2022
(86) PCT No.: PCT/EP2022/085857

§ 371 Date: Jul. 18, 2024

(30) Foreign Application Priority Data
Jan. 21, 2022 (DE) 10 2022 101 390.1
Dec. 14, 2022 (WO) PCTEP2022085857

(51) Int. Cl. H01B 17/26; H01G 11/80; H01M 50/148; H01M 50/159; H01M 50/172; H01M 50/188; H01M 50/191; H01M 50/552; H01M 50/562

(52) U.S. Cl. CPC H01B 17/26; H01G 11/80; H01M 50/148; H01M 50/159; H01M 50/172; H01M 50/188; H01M 50/191; H01M 50/552; H01M 50/562

(57) ABSTRACT

An electrical feedthrough, in particular for an electrical storage device, is provided. The electrical feedthrough comprises a main body with a through-opening and a terminal pin, which is arranged in the through-opening and is held in the through-opening in an electrically insulating manner by a fixing material. It is also provided that the terminal pin has a core of a first electrically conductive material and that, at least on a first side of the electrical feedthrough, a first end face of the core is covered by a covering material of a second electrically conductive material, wherein the terminal pin and the fixing material are formed and arranged in such a way that, on the first side of the electrical feedthrough, the first electrically conductive material of the core is inaccessible.

### CROSS REFERENCE TO RELATED APPLICATIONS

This is a continuation of PCT application no. PCT/EP2022/085857, entitled “ELECTRICAL FEEDTHROUGH AND ENERGY STORE WITH SUCH A FEEDTHROUGH”, filed Dec. 14, 2022, which is incorporated herein by reference. PCT application no. PCT/EP2022/085857 claims priority to German patent application no. 10 2022 101 390.1, filed Jan. 21, 2022, which is incorporated herein by reference.

### BACKGROUND OF THE INVENTION

### 1. Field of the Invention

The invention relates to an electrical feedthrough, in particular for an electrical storage device, comprising a main body with a through-opening and a terminal pin, which is arranged in the through-opening and is held in the through-opening in an electrically insulating manner by a fixing material. A further aspect of the invention relates to an electrical energy storage device comprising at least one such feedthrough.

### 2. Description of the Related Art

Electrical energy storage devices such as batteries or capacitors (wherein the latter include supercapacitors) are used in a variety of applications to store and provide electrical energy. The electrical energy storage devices usually comprise a housing and at least one storage cell housed in the housing. The storage cell can be electrically contacted from the outside via at least one electrical feedthrough in the housing.

Batteries within the meaning of the invention are understood to be both disposable batteries that can be disposed of and/or recycled after discharge and rechargeable batteries. Accumulators, preferably lithium-ion batteries, are intended for various applications such as portable electronic devices, cell phones, power tools and, in particular, electric vehicles. The batteries can replace traditional energy sources such as lead-acid batteries, nickel-cadmium batteries or nickel-metal hydride batteries. The battery can also be used in sensors or in the Internet of Things.

Supercapacitors, also known as supercaps, are, as is generally known, electrochemical energy storage devices with a particularly high power density. In contrast to ceramic, film and electrolytic capacitors, supercapacitors do not have a dielectric in the conventional sense. In them, the storage principles of static storage of electrical energy by charge separation in a double-layer capacitor and the electrochemical storage of electrical energy by charge exchange with the aid of redox reactions in a pseudo-capacitance are realized in particular. Supercapacitors include hybrid capacitors in particular, especially lithium-ion capacitors. Their electrolyte usually comprises a solvent in which conductive salts are dissolved, usually lithium salts. Supercapacitors are preferably used in applications where a high number of charge/discharge cycles are required. Supercapacitors are particularly advantageous in the automotive sector, especially in the field of recuperation of braking energy. Other applications are of course also possible and are covered by the invention.

Lithium-ion batteries as storage devices have been known for many years. In this regard, reference is made, for example, to “Handbook of Batteries”, David Linden, editor, 2nd edition, McCrawhill, 1995, chapters 36 and 39.

A microbattery is known from WO2021/185648 A1, which is characterized by a particularly compact design. A metal-fixing material feedthrough for an electrical connection of the microbattery can be formed as a pressure glazing, so that a particularly reliable sealing of the feedthrough is achieved.

A disadvantage of the known metal fixing material feedthroughs with pressure glazing or adapted feedthroughs is that they cannot yet be reliably manufactured with a terminal pin made of any material. Terminal pins made of a material adapted to the materials of a battery or a capacitor would be desirable, for example to prevent corrosion. Accordingly, it is an object of the invention to provide an electrical feedthrough in which the terminal pin can be adapted both to the needs of the battery and to the needs of the metal fixing material feedthrough.

### SUMMARY OF THE INVENTION

An electrical feedthrough is proposed, in particular for an electrical storage device. The electrical feedthrough comprises a main body with a through-opening and a terminal pin arranged in the through-opening, which is held in the through-opening in an electrically insulating manner via a fixing material. Furthermore, it is provided that the terminal pin has a core made of a first electrically conductive material and that at least on a first side of the electrical feedthrough a first end face of the core is covered with a covering material made of a second electrically conductive material, wherein the terminal pin and the fixing material are designed and arranged in such a way that the first electrically conductive material of the core is inaccessible on the first side of the electrical feedthrough. For this purpose, the fixing material is directly adjacent to the covering material.

The main body, the fixing material and the terminal pin form a metal-fixing material feedthrough through which the through-opening of the main body is closed. Preferably, the formed feedthrough is hermetically sealed. Hermetically sealed is defined as an He leakage rate of 1·10⁻⁸ mbar l/s at a pressure difference of 1 bar.

In particular, the main body can be a housing part for forming a housing for an electrical storage device. For example, the main body can be designed as a cover part which can be joined together with a cup-shaped housing part to form a housing for an electrical storage device. The electrical storage device can in particular be a battery or a capacitor, including a supercapacitor, wherein one or more storage cells are usually accommodated in the housing and can be electrically contacted from the outside via the electrical feedthrough as a connection terminal. The feedthrough can also be designed as a multi-pole feedthrough, in which the main body has several through-openings and a terminal pin is held in each of the through-openings via a fixing material.

It is advantageous if the first side of the electrical feedthrough, on which the first electrically conductive material of the core is inaccessible, is the side that faces inwards when a housing is formed. The first end face with covering material thus faces inwards when a housing is formed. An alternative arrangement, in which the first electrically conductive material of the core is inaccessible from the side facing outwards when a housing is formed, is of course also possible and also advantageous.

The proposed terminal pin comprises at least two different materials, wherein the first electrically conductive material of the core is preferably selected according to the requirements of the metal-fixing material feedthrough. For this purpose, the first electrically conductive material can be selected in particular with regard to the coefficient of thermal expansion and resistance to deformation. The second electrically conductive material is preferably selected according to the requirements of the electrical storage device. In particular, the second electrically conductive material can be selected with regard to chemical resistance to materials of the storage cell and electrochemical potentials.

For example, the terminal pin can have a circular cylinder shape, wherein the lateral surfaces of the cylinder face the fixing material and at least one of the end faces is covered with the covering material. In addition to the circular cylinder shape, general cylinder shapes with other end face shapes are also conceivable. For example, oval shapes or rectangles with rounded corners are conceivable. Furthermore, the terminal pin can have a so-called nail head shape, for example, which can be formed by two adjacent cylinders. A first end face of such a nail head-shaped terminal pin is formed by an end face of the cylinder with the larger end face, and a second end face is formed by an end face of the cylinder with the smaller end face.

In addition to covering a first end face of the core with the covering material, it is also possible to cover a second end face of the core opposite the first end face with a further covering material made of a third electrically conductive material. The third electrically conductive material can be selected to be identical to or different from the second electrically conductive material. With different choices, the second electrically conductive material in particular can be adapted to the requirements of the materials of a storage cell, and the third electrically conductive material can, for example, be optimized for simple and safe connection to electrical terminals. Welding properties or soldering properties, for example, can be used as a criterion for material selection.

In one variant of the invention, a lateral surface of the core facing the fixing material is at least partially not covered with covering material and is directly adjacent to the fixing material. Preferably, the lateral surface of the core is completely free of the covering material. In another variant of the invention, the surface of the core is completely covered with covering material, so that in particular the lateral surface is also completely covered with covering material.

Preferably, the melting point of the fixing material is lower than the melting point of all materials of the terminal pin. This ensures that the terminal pin is not damaged when manufacturing the metal-fixing material feedthrough using a temperature treatment step, for example for sintering or vitrifying the fixing material.

In such a temperature treatment step, the fixing material can be obtained from a compact comprising, for example, a glass powder or a glass-ceramic powder or a ceramic powder. The glass powder may consist of or comprise a partially crystallizable glass, so that during a temperature treatment the partially crystallizable glass is ceramized and a glass ceramic is obtained.

Preferably, the second electrically conductive material and/or the third electrically conductive material is applied to the end face of the core by means of cladding, electroplating, coating, vapor deposition, welding or soldering. If only comparatively small thicknesses of the covering material are applied, electroplating, coating and vapor deposition are preferred. Conversely, cladding, welding and soldering are preferred when comparatively high thicknesses of the covering material are applied.

During cladding, the starting materials, for example the covering material and the core material, are usually provided in the form of sheets or strips, placed on top of each other and joined together by rolling. During soldering or welding, for example, the covering material can be placed on the core material in the form of a sheet or foil and welded or soldered to it.

Possible vapor deposition processes include physical vapor deposition (PVD) such as sputtering, chemical vapor deposition (CVD) or plasma-enhanced chemical vapor deposition (PECVD).

Regardless of the method of application, the covering material is preferably arranged free of openings or imperfections so that the corresponding end face of the core is completely covered. In particular, this is intended to prevent the first conductive material from coming into contact with materials from the interior of an energy store.

Furthermore, the covering material is preferably selected and arranged in such a way that it is suitable for soldering or welding on electrical contacts such as contact lugs. Accordingly, the covering material is preferably designed in such a way that it is suitable for soldering or welding on electrical contacts and no cracks or openings occur in the covering material.

Preferably, one or both end faces of the terminal pin are arranged flush with a surface of the main body. If the main body has areas with different thicknesses, it is preferred that one or both end faces are flush with the surface of the main body adjacent to the through-opening. Especially in combination with a fixing material that is flush with the surface of the main body, this achieves a flat form of the electrical feedthrough and the feedthrough advantageously has the lowest possible overall height.

Alternatively, it is preferred that one or both end faces of the terminal pin protrude beyond a surface of the main body. If the main body has areas with different thicknesses, it is preferred that one or both end faces protrude beyond the surface of the main body adjacent to the through-opening. This creates an increased contact surface which allows easy electrical contacting of the terminal pin, for example by the welding on of contact lugs.

The material of the main body and/or the first electrically conductive material of the core of the terminal pin are preferably selected from steel, in particular ferritic, austenitic or duplex steel, stainless steel, high-grade steel, iron-nickel alloys, iron-nickel-cobalt alloys, KOVAR, molybdenum, titanium, titanium alloy, aluminum or aluminum alloy.

A preferred example has a main body made of austenitic steel and a terminal pin with a core made of ferritic steel.

The second electrically conductive material and/or the third electrically conductive material of the terminal pin is preferably selected from aluminum, an aluminum alloy, AlSiC, copper, a copper alloy, molybdenum, nickel or nickel alloys, palladium, silver or gold.

A preferred example of a terminal pin according to the invention has a core made of a stainless steel, in particular a ferritic stainless steel, and a covering material made of aluminum or an aluminum alloy.

However, other material combinations in which a melting point of the second electrically conductive material and/or the third electrically conductive material is lower than a melting point of the first electrically conductive material of the core of the terminal pin are also preferred.

Preferably, the fixing material is a glass, a glass-ceramic or a ceramic or comprises a glass, a glass-ceramic or a ceramic.

Preferred glasses include technical glasses, in particular oxidic glasses, which are preferably chemically resistant to conventional materials in conjunction with electrical energy stores.

In the case of a technical glass, the fixing material is, for example, an aluminum borate glass, which comprises Al₂O₃ and B₂O₃, or a bismuth glass, which comprises, for example, Bi₂O₃ as a glass former. Alternatively, glasses comprising lead oxide as a glass former, in particular glasses from the PbO—B₂O₃ system, or vanadium-containing glasses can also be used as a fixing material.

For glass-to-metal feedthroughs, suitable glasses are selected as fixing materials according to their properties such as melting temperature and/or coefficient of expansion. Glasses with a low melting temperature can be advantageous. A glass of which the melting temperature is below the melting point of aluminum or an aluminum alloy is particularly advantageous. It may be preferable if, in an electrical feedthrough for an electrical storage device, for example a battery, a capacitor or a supercapacitor, the fixing material comprises or consists of a bismuth-based glass comprising Bi₂O₃ as glass former or a lead-based glass comprising PbO as glass former.

To produce the electrical feedthrough, the fixing material or a precursor material can be provided in the form of a formed body. The formed body can, for example, have the shape of a hollow cylinder. To form the electrical feedthrough, the terminal pin is inserted into the interior of this hollow cylinder, which in turn is inserted into an opening in a main body. The metal pin is then vitrified into the opening by heat treatment, wherein the fixing material forms an intimate bond with the material of the terminal pin and the material of the main body.

If the main body is designed as a housing part for an electrical energy storage device, e.g., as a cover part of a micro-battery, the main body has a thickness in the range from 0.1 mm to 1 mm, preferably from 0.2 mm to 0.6 mm, for example.

Preferably, the main body has a first thickness d₁ outside the area of the through-opening and an increased second thickness d₂ in a reinforcement area with a width W adjacent to the through-opening. If the metal-fixing material feedthrough is designed as a pressure glazing, the width W is selected so that sufficient compressive forces can be exerted on the fixing material by the main body. For example, the width W is selected in the range from 0.6 mm to 1 mm.

This increased thickness of the reinforcement area can be achieved, for example, by providing thickened areas of the main body of the housing part, providing a collar and/or providing reinforcement parts. The choice of the thickness of the main body or the provision of thickened areas can influence the glazing length along which the fixing material is connected to the material of the main body of the housing part.

In one variant, the housing part has a collar that forms an inner wall with a height that is greater than the remaining material thickness of the housing part, in particular a thickness of a housing part designed as a cover or a thickness of a wall of a housing part designed as a cup.

Preferably, the collar is designed as a high-domed, re-shaped collar, wherein the housing part and the collar are in particular formed in one piece.

In order to avoid breakage of the glass, ceramic or glass-ceramic material, particularly after vitrification, for example due to the effects of temperature, it is advantageous if the main body comprises a flexible flange for joining the main body to other components such as parts of a housing. The flange itself comprises an area, a so-called connection area, with which a further component is connected to the main body. The connection to the main body can be made by welding, in particular ultrasonic welding or soldering. The welded connection is preferably made in such a way that the connection is largely gas-tight and preferably provides a He leakage rate of less than 10⁻⁸ mbar l/sec at a pressure difference of 1 bar.

The flexible flange can be obtained very easily. For example, the main body can be designed as a sheet metal part with a thickness d₂, which is stamped down to the thickness d₁, and after the stamping down, the portion with the thickness d₁ is deformed so that the flexible flange is formed. It is possible that the original thickness d₂ is retained around the area of the opening, so that the area adjacent to the opening is reinforced. It is also possible that a sheet with a thickness d₁ is formed into a flexible flange and the raised sheet or a collar formed by shaping the sheet accommodates the glazing. Glazing in a raised flexible flange, in particular on a collar of the flexible flange, is particularly possible if the flexible flange and the raised area comprise austenitic steel or duplex steel as the material.

In an advantageous embodiment, a relief device can be provided in the main body instead of or in addition to a flexible flange. The relief device advantageously comprises at least one groove or recess, preferably at least one circumferential groove or circumferential recess. Instead of one groove, a series of adjacent recesses can also be provided.

The relief device can reduce a thermal flow through the main body, i.e., create a thermal barrier, and/or reduce mechanical stress on the main body perpendicular to the axis of the terminal pin, since the main body is deformable, preferably reversibly deformable, in the direction perpendicular to the axis of the terminal pin. This results in less stress being introduced into the fixing material, in particular no tensile stresses acting on the fixing material and thereby reducing the compression on the fixing material, which improves the tightness of the feedthrough under thermal and mechanical loads.

In an advantageous first variant, the relief device, in particular groove or recess, is arranged on the second side of the electrical feedthrough, which faces outwards when a housing is formed. In an advantageous alternative second variant, the relief device, in particular groove or recess, is arranged on the first side of the electrical feedthrough, which faces inwards when a housing is formed. In a particularly advantageous third variant, the relief device comprises at least two grooves or recesses arranged on opposite sides of the main body. For example, an aluminum borate glass with the main components Al₂O₃, B₂O₃, BaO and SiO₂ is used as the glass or glass-ceramic material. Preferably, the coefficient of expansion of such a glass material is in the range 9.0 to 9.5 ppm/K. or 9.0 to 9.5·10⁻⁶/K. If, for example, a bismuth glass is used, the coefficient of expansion is approximately 10.5·10⁻⁶/K.

In order to achieve a particularly good seal between the metal parts, i.e., the main body and the terminal pin, and the fixing material, the electrical feedthrough can be designed in the form of a pressure glazing. A coefficient of thermal expansion of the main body is selected that is greater than a coefficient of thermal expansion of the fixing material, so that after a temperature treatment in which the fixing material is vitrified in the through-opening, the main body contracts more than the fixing material. As a result, the main body exerts permanent compressive forces on the fixing material. These pretension the fixing material and ensure a particularly durable seal.

Accordingly, it is preferred that a coefficient of thermal expansion of the main body is greater than a coefficient of thermal expansion of the fixing material. It is particularly preferred that the coefficient of thermal expansion of the main body is at least 5%, preferably at least 10%, particularly preferably at least 20% and most preferably at least 50% greater than the coefficient of thermal expansion of the fixing material in the case of pressure glazing.

The prestressing for the pressure glazing is substantially determined by the difference in the coefficients of expansion between the material of the main body and the fixing material.

Preferably, the coefficient of expansion of the main body is in the range 12·10⁻⁶ 1/K to 19·10⁻⁶ 1/K and the coefficient of expansion of the fixing material is in the range 9·10⁻⁶ 1/K to 11·10⁻⁶ 1/K.

The coefficient of expansion of the glass, ceramic or glass-ceramic material can be modified if necessary by mixing the glass, ceramic or glass-ceramic material with a filler. The coefficient of thermal expansion can then be adjusted by selecting the type and quantity of filler.

The coefficient of expansion of the core of the terminal pin is preferably in the range of 6·10⁻⁶ 1/K to 11·10⁻⁶ 1/K. Accordingly, the coefficient of expansion of the core is preferably adapted to the coefficient of expansion of the fixing material or is selected to be slightly lower when the feedthrough is embodied as a pressure glazing.

For pressure glazing, for example, an austenitic steel with a coefficient of expansion of approximately 16·10⁻⁶ 1/K can be combined with a bismuth-based glass with a coefficient of expansion of approximately 10.5·10⁻⁶ 1/K and a core of ferritic steel with a coefficient of expansion of approximately 10·10⁻⁶ 1/K.

As an alternative to pressure glazing, the coefficient of expansion of the main body and the coefficient of expansion of the fixing material can be adapted to each other. It is preferable if the difference between the coefficients of expansion is less than 5%.

In particular, an adapted feedthrough is understood to mean that the coefficients of expansion substantially differ by a maximum of 1*10⁻⁶ 1/K, in particular are substantially the same. The coefficient of expansion of the core of the terminal pin is preferably adapted in the same way to the coefficient of expansion of the fixing material.

Where values for the coefficient of expansion are given above in conjunction with pressure glazing or adapted glazing for materials, these refer to the linear coefficient of thermal expansion a in the temperature interval 20-300° C. usually specified in conjunction with glass-to-metal feedthroughs.

A safety valve and/or a predetermined breaking point is usually provided as a safety element on housings for an energy storage device in order to reduce the internal pressure in a controlled manner in the event of overpressure. The electrical feedthrough preferably has such a safety element. For this purpose, it is preferable to select a press-out force for the terminal pin held by the fixing material in such a way that the terminal pin is pressed out when a predetermined press-out force is exceeded. Such an adjustment of the press-out force is known, for example, from DE 2020 20106 518 U1.

Preferably, the fixing material and its connection to the wall of the through-opening and the terminal pin is designed in such a way that a safety valve function is provided via a predetermined press-out force, wherein the predetermined press-out force is set by one or more of the following measures:
a. selection of the thickness of the glazing,
b. selection of the fixing material,
c. selection of the bubble content in the fixing material,
d. structuring of the surface of the fixing material by adjusting the shape of a fixing material formed body prior to the glazing process,
e. structuring of the surface of the fixing material during the glazing process,
f. laser processing of the surface of the fixing material after the glazing process,
g. forming of notches or tapers in the fixing material on one or two sides, and/or
h. forming of notches or tapers in the terminal pin and/or the main body.

Preferably, the second electrically conductive material and/or the fixing material are selected in such a way that they are resistant to electrolytes, in particular aqueous and/or non-aqueous electrolytes. In particular, it is preferred if the feedthrough materials have a high chemical resistance to non-aqueous battery electrolytes, in particular to carbonates, preferably carbonate mixtures with a conducting salt, preferably comprising LiPF₆.

A further aspect of the invention is the provision of an electrical storage device. The proposed electrical storage device is in particular designed as a battery or as a capacitor, including a supercapacitor, and comprises a housing with at least one of the electrical feedthroughs described herein. Furthermore, the electrical storage device preferably comprises at least one storage cell, in particular a battery cell or a capacitor cell.

Preferably, the main body of the electrical feedthrough is designed as a housing part, in particular as a cover, which is preferably hermetically sealed to other housing parts, so that a hermetically sealed housing is formed for the electrical storage device. For example, to form the housing, a cover is connected to the electrical feedthrough by welding to a cup. Hermetically sealed here means that the housing has an He leakage rate of less than 10⁻⁸ mbar l/sec at a pressure difference of 1 bar.

### BRIEF DESCRIPTION OF THE DRAWINGS

The invention will be described in greater detail below with reference to the figures and without limitation thereto.

In the figures:

FIG. 1 shows a first exemplary embodiment of an electrical feedthrough with a flush design of the terminal pin;

FIG. 2 shows a second exemplary embodiment of an electrical feedthrough with surfaces of the terminal pin protruding beyond a main body;

FIG. 3 shows a third exemplary embodiment of an electrical feedthrough with the core of the terminal pin covered on both sides and a reinforcement area;

FIG. 4 shows a fourth exemplary embodiment of an electrical feedthrough with a flexible flange;

FIG. 5 shows a fifth exemplary embodiment of an electrical feedthrough with a fully coated core of the terminal pin;

FIG. 6 shows a sixth exemplary embodiment of an electrical feedthrough with a flexible flange; and

FIG. 7 shows a seventh exemplary embodiment of an electrical feedthrough with a relief device.

### DETAILED DESCRIPTION OF THE INVENTION

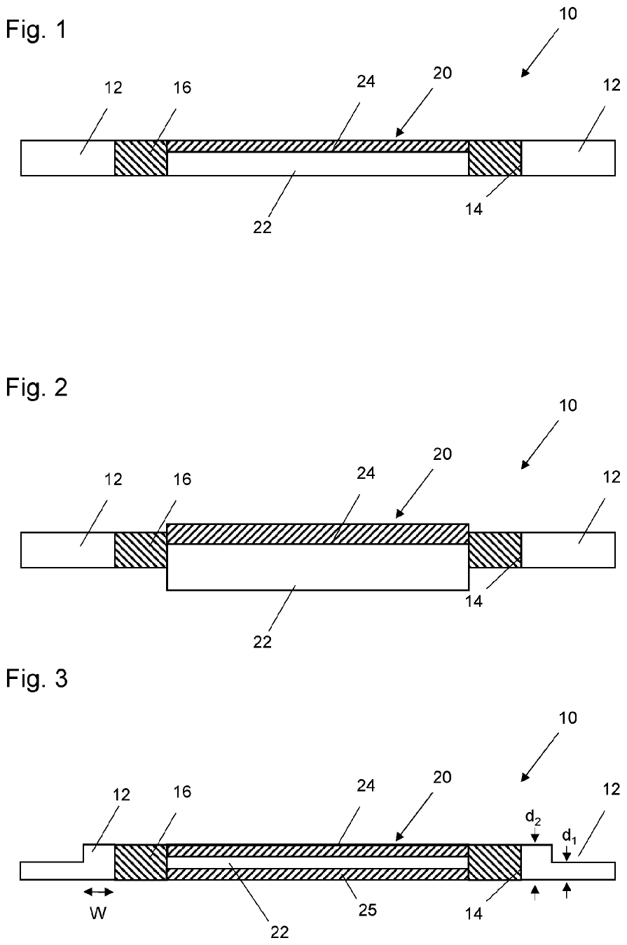

FIG. 1 shows a first exemplary embodiment of an electrical feedthrough 10. The electrical feedthrough 10 comprises a main body 12 with a through-opening 14 into which a terminal pin 20 is inserted. The terminal pin 20 is held in the through-opening 14 in an electrically insulating manner via a fixing material 16. The fixing material 16 seals both against an inner wall of the through-opening 14 and against the terminal pin 20, so that the through-opening 14 is tightly closed by the fixing material 16 and a metal-fixing material feedthrough is formed.

The electrical feedthrough 10 shown is particularly suitable for use in conjunction with electrical storage devices such as batteries, in particular microbatteries, and capacitors. Accordingly, the main body 12 can be a component of a housing for such an electrical storage device, for example a battery cover. The terminal pin 20 then forms a connection terminal of the electrical storage device, for example. To form a housing for the electrical storage device, the main body 12 of the electrical feedthrough is joined together with other housing parts. If the main body 12 is designed as a cover part, a housing for an electrical storage device can be formed by joining the cover part with a cup part. At least one storage cell, such as a battery cell or a capacitor cell, is usually arranged inside such a storage device. To establish an electrical connection, one connection of such a storage cell can be electrically conductively connected to the terminal pin 20 and another connection to a further housing part. Of course, it is also possible to form several through-openings 14 in a main body 12 and to arrange several terminal pins 20 so that a multi-pole feedthrough is provided.

The material properties of the terminal pin 20, in particular its coefficient of thermal expansion, must be adapted to the requirements of the metal-fixing material feedthrough formed. In order to prevent or at least reduce corrosion of the terminal pin 20, the material of the terminal pin 20 should also be adapted to the materials used in the storage cell, such as the materials of the current arresters, electrode materials and electrolytes. In order to fulfill both requirements, it is provided according to the invention that the terminal pin 20 has a core 22 made of a first electrically conductive material which is adapted to the requirements of the metal fixing material feedthrough, and has a covering material 24 made of a second electrically conductive material on one end face, which is adapted to the requirements of the storage cell in order to prevent or at least reduce corrosion. The covering material 24 and the fixing material 16 are arranged in the electrical feedthrough 10 in such a way that the core material 22 of the terminal pin is inaccessible on a first side of the feedthrough on which the covering material 24 is located. For this purpose, the covering material 24 is directly adjacent to the fixing material 16. The covering material 24 is located on the side of the electrical feedthrough 10 that faces inwards when a housing is formed. The second electrically conductive material can, for example, be applied to the end face of the core 22 of the terminal pin 20 by cladding. However, other variants are also conceivable for applying the second electrically conductive material. For example, thin sheets or foils of the second electrically conductive material can be connected to the core 22 by welding or soldering, or the second electrical material can be applied by electroplating or a vapor deposition process.

In the first exemplary embodiment of FIG. 1, a lateral surface of the core 22 of the terminal pin 20 remains free of the covering material 24. This ensures that the covering material 24 does not change the properties of the metal-fixing material feedthrough. The two materials can therefore be selected completely independently of each other in order to achieve optimum adaptation to the requirements of the storage cells inside the housing and to the formation of the metal-fixing material feedthrough. For example, in the case of an embodiment of the electrical feedthrough 10 for use in a lithium-ion battery, aluminum can be used as the covering material 24. If the metal-fixing material feedthrough is formed as a pressure glazing, the first electrically conductive material for the core 22 of the terminal pin can, for example, be a stainless steel, so that the core 22 does not deform under the compressive forces that occur.

In the exemplary embodiment of the electrical feedthrough 10 shown in FIG. 1, both end faces of the terminal pin 20 are flush with the corresponding surfaces of the main body 12. The overall thickness of the terminal pin 20 thus corresponds to the thickness of the main body 12. In addition, the surface of the fixing material 16 is flush with the surfaces of the main body 12 and the end faces of the terminal pin 20. However, it would also be conceivable that the fixing material 16 protrudes beyond the surfaces and partially covers adjacent areas of the terminal pin 20 and/or the main body 12. Furthermore, it is alternatively conceivable that one or both end faces of the terminal pin 20 protrude beyond the corresponding surfaces of the main body 12. This is shown as an example in FIG. 2.

FIG. 2 shows a second exemplary embodiment of the electrical feedthrough 10 with surfaces of the terminal pin 20 protruding beyond the main body 12. The structure of the electrical feedthrough 10 corresponds to the first embodiment described with reference to FIG. 1. Deviating from this, the terminal pin 20 is designed and arranged in such a way that its end faces are not arranged flush with the corresponding surfaces of the main body 12. The overall thickness of the terminal pin 20 is thus greater than the thickness of the main body 12. FIG. 2 shows that the thickness of the covering material 24 is selected to be so great that, in conjunction with the fixing material 16, the first electrically conductive material of the core 22 is nevertheless not accessible from this side of the electrical feedthrough 10. Accordingly, the fixing material 16 is also directly adjacent to the covering material 24.

If, as shown in this second exemplary embodiment, the covering material 24 protrudes beyond the surface of the main body 12, comparatively large thicknesses are preferred for the covering material 24. These can be achieved in particular by cladding the core 22 or joining a sheet or a foil to the core 22 by welding or soldering.

Of course, it is conceivable that one of the two end faces of the terminal pin 20 is arranged flush with the corresponding surface of the main body 12, so that the terminal pin 20 only protrudes beyond the main body 12 on one of the two sides.

FIG. 3 shows a third exemplary embodiment of the electrical feedthrough 10. As described with reference to the first embodiment of FIG. 1, the electrical feedthrough 10 has a main body 12 with a through-opening 14, in which a terminal pin 20 is held in an insulating manner via a fixing material 16.

Deviating from the first embodiment of FIG. 1, a further covering material 25 made of a third electrically conductive material is additionally arranged on a second end face of the core 22, so that both end faces of the core 22 of the terminal pin 20 are covered with covering material 24, 25. The further covering material 25 is also directly adjacent to the fixing material 16, so that in this embodiment the first electrically conductive material of the core 22 is completely enclosed within the electrical feedthrough 10. The third electrically conductive material may be different or identical to the second electrically conductive material. Identical materials are shown as examples.

In the third exemplary embodiment of FIG. 3, the main body 12 is also designed differently from the first two embodiments. The main body 12 of the third exemplary embodiment has a reinforcement area with a width W, which is adjacent to the through-opening 14 and within which the main body 12 has an increased thickness d₂. Outside the reinforcement area, the main body 12 has a reduced thickness d₁. This results in a particularly compact structure of the electrical feedthrough 10, which is particularly suitable for microbatteries. Nevertheless, the main body 12 offers high mechanical stability, which is also suitable for forming the metal-fixing material feedthrough as pressure glazing. For this purpose, the width W is selected in such a way that the necessary compressive forces can be built up.

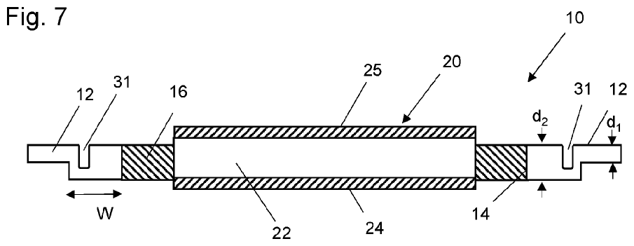

The embodiment of the main body 12 with a reinforcing region can of course be combined with other exemplary embodiments, so that, for example, in deviation from the representation of FIG. 3, one or also both end faces of the terminal pin 20 can project beyond the surfaces of the main body 12 adjacent to the through-opening 14 (see FIG. 7) or only a first end face of the core 22 is covered with a covering material 24.

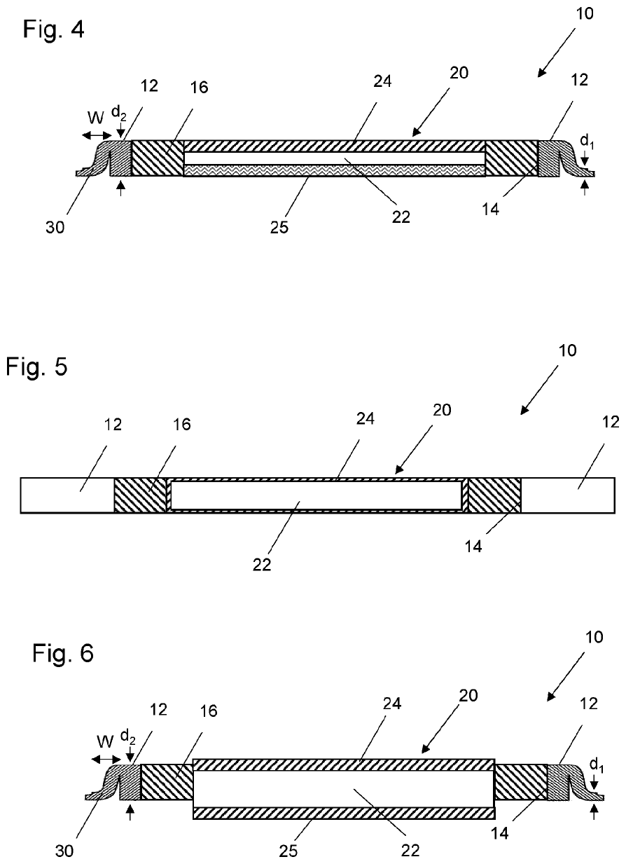

FIG. 4 shows a fourth exemplary embodiment of an electrical feedthrough 10. As described with reference to the first embodiment of FIG. 1, the electrical feedthrough 10 has a main body 12 with a through-opening 14, in which a terminal pin 20 is held in an insulating manner via a fixing material 16. As shown in the third exemplary embodiment of FIG. 3, the core 22 of the terminal pin 20 is provided with covering material 24, 25 on both end faces, wherein in the example shown the end faces of the terminal pin are flush with a surface of the main body 12 adjacent to the through-opening 14. As can be seen in the figure, in this example the further covering material 25 with the third electrically conductive material is selected differently from the covering material 24 with the second electrically conductive material.

The main body 12 of the fourth exemplary embodiment additionally comprises a flexible flange 30, via which the main body 12 can be connected to further elements, for example to further components of a housing. The flexible flange 30 is obtained, for example, by forming the main body 12 and has a transition area with a width W, within which a flat portion of the main body 12 merges into a glazing portion with a thickness d₂, which is greater than the thickness d₁ of the flat portion of the main body 12. The main body 12 is flexible and compliant in the transition area, so that the area with the through-opening 14 is mechanically decoupled by the flexible flange 30. Accordingly, mechanical stresses from other parts of the housing are not transferred to the fixing material 16. Furthermore, the thickness d₂ within the glazing portion can be freely selected over a wide range, so that a glazing length can be set independently of other dimensions of the main body 12 or of a housing with the main body.

FIG. 5 shows a fifth exemplary embodiment of an electrical feedthrough 10, which is similar to the first exemplary embodiment of FIG. 1. In contrast to the first exemplary embodiment, the core 22 of the terminal pin 20 is completely coated, so that all surfaces of the core 22 are covered by the covering material 24. Accordingly, in particular both end faces and a lateral surface of the core 22 are covered by the covering material 24.

FIG. 6 shows a sixth exemplary embodiment of an electrical feedthrough 10, which is designed similarly to the fourth exemplary embodiment of FIG. 4 and comprises a flexible flange 30, the design and function of which have already been described above. The core 22 of the terminal pin 20 with the first electrically conductive material is, as shown in the fourth exemplary embodiment of FIG. 4, provided with covering material 24, 25 on both end faces, wherein the covering materials 24, 25 are identical here by way of example. Deviating from the fourth exemplary embodiment, the terminal pin 20 is designed and arranged in such a way that its end faces are not arranged flush with the corresponding surfaces of the main body 12, but protrude beyond them. The overall thickness of the terminal pin 20 is therefore greater than the thickness of the main body 12 in the area of the feedthrough. It can be seen in FIG. 6 that the arrangement of the core 22 and the thickness of the covering material 24 with the second electrically conductive material are selected to be so large that, in conjunction with the fixing material 16, the first electrically conductive material of the core 22 is not accessible from one side of the electrical feedthrough 10. Accordingly, the fixing material 16 is also directly adjacent to the covering material 24. The covering material 24 is located on the first side of the electrical feedthrough 10, which faces inwards when a housing is formed. On the opposite second side of the feedthrough 10, which faces outwards when a housing is formed, the first electrically conductive material of the core 22 is accessible in the exemplary embodiment shown, since here the fixing material 16 is not directly adjacent to the covering material 25.

In a particularly advantageous embodiment of the sixth exemplary embodiment, the terminal pin 20 has a core 22 made of ferritic steel as the first electrically conductive material and, on both sides of the core 22, a covering material 24, 25 made of aluminum or an aluminum alloy as the second electrically conductive material. The main body 12 is made of a steel with a higher coefficient of expansion than the material of the core 22; in particular austenitic steel is selected as the material for the main body 12. If a low-melting bismuth-based fixing material 16 is selected, a hermetically sealed pressurized enclosure can be provided in combination with a main body 12 made of austenitic stainless steel.

If the core 22 is selected from ferritic steel, the terminal pin 20 is adapted to the requirements of the formed metal-fixing material feedthrough with regard to its material properties, in particular with regard to its coefficient of thermal expansion. In order to prevent or at least reduce corrosion of the terminal pin 20, the core 22 is provided with a covering material 24 made of aluminum or an aluminum alloy on its side which faces inwards when a housing is formed and is thus adapted to the requirements of the materials of a storage cell, e.g., chemical resistance, electrochemical potentials. If the core 22 is provided with a covering material 25 made of aluminum or an aluminum alloy on its opposite side, which faces outwards when forming a housing, the terminal pin 20 can be optimized for simple and secure connection, e.g., soldering or welding, to electrical connections, for example.

FIG. 7 shows a seventh exemplary embodiment of an electrical feedthrough 10, which is similar to the third exemplary embodiment in FIG. 3. The main body 12 of the seventh exemplary embodiment also has a reinforcement area with a width W, which is adjacent to the through-opening 14 and within which the main body 12 has an increased thickness d₂. Outside the reinforcement area, the main body 12 has a reduced thickness d₁. The advantages of such an embodiment have already been described above.

In the seventh exemplary embodiment, a relief device 31 is provided in the main body 12 and is formed here by way of example as a groove or recess, preferably as a circumferential groove or circumferential recess. The groove of the relief device 31 is arranged by way of example on the second side of the electrical feedthrough 10, which faces outwards when a housing is formed. Of course, it could also be arranged on the other side of the housing. Two grooves or recesses arranged on opposite sides of the main body can also serve as a relief device 31. Instead of a groove, a series of adjacent recesses can also be provided.

The relief device 31 reduces a thermal flow through the main body 12, i.e., creates a thermal barrier, and/or reduces mechanical stress on the main body 12 perpendicular to the axis of the terminal pin 20, since the main body 12 is deformable, preferably reversibly deformable, in the direction perpendicular to the axis of the terminal pin 20. As a result, fewer stresses, in particular no tensile stresses, which act on the fixing material 16 and thereby reduce the compression on the fixing material 16, are introduced into the fixing material 16, thereby ensuring the tightness of the bushing 10 under thermal and mechanical loads.

Deviating from the third exemplary embodiment, the terminal pin 20 of the seventh exemplary embodiment is designed and arranged here as in the sixth exemplary embodiment. Here too, the covering material 24 with the second electrically conductive material is located on the first side of the electrical feedthrough 10, which faces inwards when a housing is formed, so that the core 22 of the terminal pin 20 is not accessible from the inside. On the opposite second side of the feedthrough 10, which faces outwards when a housing is formed, the first electrically conductive material of the core 22 is also accessible here, since here the fixing material 16 is not directly adjacent to the covering material 25. The advantageous combination of materials mentioned in conjunction with the sixth exemplary embodiment can also be advantageous for an embodiment of a feedthrough 10 with a relief device 31.

Although the present invention has been described with reference to preferred exemplary embodiments, it is not limited to these, but can be modified in many ways, in particular by combining the features described with reference to different exemplary embodiments (such as the design of the main body—with reinforcing device, relief device, flexible flange —, design and arrangement of the terminal pin, choice of materials of the components) to form further examples which make use of the technical teaching of the invention.

### LIST OF REFERENCE SIGNS

10 electrical feedthrough
12 main body
14 through-opening
16 fixing material
20 terminal pin
22 core
24 covering material
25 further covering material
30 flexible flange
31 relief device
d1 first thickness
d2 second thickness
W width

1-17. (canceled)

18. An electrical feedthrough, comprising:
a main body including a through-opening;
a fixing material;
a first side; and
a terminal pin, which is arranged in the through-opening and is held in the through-opening in an electrically insulating manner via the fixing material, the terminal pin including a core and a first covering material, the core including a first electrically conductive material and a first end face, at least on the first side of the electrical feedthrough the first end face being covered with the first covering material which includes a second electrically conductive material, the terminal pin and the fixing material being configured and arranged in such a way that the first electrically conductive material of the core is inaccessible on the first side of the electrical feedthrough.

19. The electrical feedthrough according to claim 18, wherein the terminal pin includes a second covering material, wherein the core includes a second end face opposite the first end face, the second end face being covered with the second covering material which includes a third electrically conductive material which is identical to or different from the second electrically conductive material, wherein the electrical feedthrough is configured for an electrical storage device.

20. The electrical feedthrough according to claim 19, wherein the core includes a lateral surface (i) which faces the fixing material and (ii) which is covered at least partially with neither the first covering material nor the second covering material and (iii) which is directly adjacent to the fixing material.

21. The electrical feedthrough according to claim 19, wherein a melting point of the fixing material is lower than a melting point of all materials of the terminal pin.

22. The electrical feedthrough according to claim 19, wherein at least one of the second electrically conductive material and the third electrically conductive material is configured for being applied to at least one of the first end face and the second end face by way of cladding, electroplating, coating, vapor deposition, welding, or soldering.

23. The electrical feedthrough according to claim 19, wherein the main body includes a flexible flange.

24. The electrical feedthrough according to claim 19, wherein the main body includes a region of the through-opening and a region adjacent to the through-opening, wherein the main body has a first thickness d₁ outside the region of the through-opening and has a second thickness d₂ in the region adjacent to the through-opening, the second thickness d₂ being greater than the first thickness d₁.

25. The electrical feedthrough according to claim 19, wherein the main body includes a surface, wherein at least one of the first end face and the second end face of the terminal pin are arranged flush with the surface of the main body.

26. The electrical feedthrough according to claim 19, wherein the main body includes a surface, wherein at least one of the first end face and the second end face of the terminal pin are arranged projecting beyond the surface of the main body.

27. The electrical feedthrough according to claim 19, wherein the main body includes a material, wherein at least one of the material of the main body and the first electrically conductive material of the core of the terminal pin are selected from steel, iron-nickel alloys, iron-nickel-cobalt alloys, KOVAR, molybdenum, or titanium.

28. The electrical feedthrough according to claim 27, wherein the steel is ferritic steel, austenitic steel, duplex steel, stainless steel, or high-grade steel.

29. The electrical feedthrough according to claim 19, wherein at least one of the second electrically conductive material and the third electrically conductive material of the terminal pin is selected from aluminum, an aluminum alloy, AlSiC, copper, a copper alloy, molybdenum, nickel, nickel alloys, palladium, silver, or gold.

30. The electrical feedthrough according to claim 19, wherein a melting point of at least one of the second electrically conductive material and the third electrically conductive material is lower than a melting point of the first electrically conductive material of the core of the terminal pin.

31. The electrical feedthrough according to claim 18, wherein:
the fixing material is a glass, a glass-ceramic, or a ceramic; or
the fixing material comprises a glass, a glass-ceramic, or a ceramic.

32. The electrical feedthrough according to claim 18, wherein:
a coefficient of expansion of the main body is greater than a coefficient of expansion of the fixing material; or
a coefficient of expansion of the main body and a coefficient of expansion of the fixing material are matched to one another.

33. The electrical feedthrough according to claim 18, wherein the through-opening includes a wall, the fixing material being in a connection with the wall of the through-opening, wherein the fixing material, the connection of the fixing material with the wall of the through-opening, and the terminal pin are configured in such a way that a safety valve function is provided by way of a predetermined press-out force, wherein the predetermined press-out force is set by at least one of the following measures:
a. selection of a thickness of a glazing;
b. selection of the fixing material;
c. selection of a bubble content in the fixing material;
d. structuring of a surface of the fixing material by adjusting a shape of a fixing material formed body prior to a glazing process;
e. structuring of a surface of the fixing material during a glazing process;
f. laser processing of a surface of the fixing material after a glazing process;
g. forming of a plurality of notches or a plurality of tapers in the fixing material on at least one side or two sides of the fixing material; and
h. forming of a plurality of notches or a plurality of tapers in at least one of the terminal pin and the main body.

34. The electrical feedthrough according to claim 18, wherein the main body includes a relief device.

35. An electrical storage device, comprising:
a housing with at least one electrical feedthrough, the at least one electrical feedthrough including:
a main body including a through-opening;
a fixing material;
a first side; and
a terminal pin, which is arranged in the through-opening and is held in the through-opening in an electrically insulating manner via the fixing material, the terminal pin including a core and a first covering material, the core including a first electrically conductive material and a first end face, at least on the first side of the electrical feedthrough the first end face being covered with the first covering material which includes a second electrically conductive material, the terminal pin and the fixing material being configured and arranged in such a way that the first electrically conductive material of the core is inaccessible on the first side of the electrical feedthrough.

36. The electrical storage device according to claim 35, wherein the electrical storage device is a battery or a capacitor.
